(19) United States
(12) Patent Application Publication
(10) Pub. No.: US 2002/0069416 A1
(43) Pub. Date: Jun. 6, 2002

(54) METHODS AND APPARATUS FOR MULTIPOINT-TO-MULTIPOINT HIERARCHICAL REDISTRIBUTION OF MULTIMEDIA CONTENT

(76) Inventor: HERSCHEL W. STILES, SAN JOSE, CA (US)

Correspondence Address: JOYCE KOSINSKI, PATENT ADMINISTRATOR, LORAL SPACE & COMMUNICATIONS, 655 DEEP VALLEY DR SUITE 303, ROLLING HILLS ESTATES, CA, 90274

(21) Appl. No.: 09/193,976

(22) Filed: Nov. 18, 1998

(51) Int. Cl. H04H 1/00; H04B 7/24; H04N 7/20; G06F 15/16; H04Q 7/20

(52) U.S. Cl. 725/63; 725/71; 455/427; 455/39; 455/3.01

(57) ABSTRACT

Multipoint-to-multipoint hierarchical redistribution of multimedia content derived from one or more network operations centers that distributes multimedia content by way of a satellite is disclosed. Apparatus in accordance with the present invention comprises one or more network operations bridges that communicate with and receive the multimedia content generated at the network operations center by way of the satellite. Each of the network operations bridges selectively communicate with one or more multimedia content delivery systems or user terminals that are relatively local to the respective network operations bridges. Using an exemplary method, multimedia content is uplinked from a network operations center 30 to the satellite. The multimedia content is then downlinked from the satellite to one or more network operations bridges. The multimedia content is redistributed from the one or more network operations bridges to one or more multimedia content delivery systems or user terminals.

### BACKGROUND

The present invention relates generally to multimedia content distribution, and more particularly, to methods and apparatus that provide multipoint-to-multipoint hierarchical redistribution of multimedia content.

U.S. Pat. No. 5,534,913 issued to Majeti, et. al. discloses a method and apparatus for integrating downstream data transfer over a cable TV system with upstream data carrier using other media. U.S. Pat. No. 5,534,913 discloses a split channel bridging unit includes a router that operates under the control of a control processor to route packets of information destined for a user to a modulator which is connected to a cable distribution head-end of a cable television system that serves a requesting user.

The modulator encodes digital information transmitted from the router and encodes it in an RF channel to be carried by the television cable. The cable distribution head-end combines this channel with other conventional cable television sources to broadcast these channels to its users. Customer premises equipment of the user includes an RF demodulator and packet receiver which demodulates the RF encoded signals and utilizes the packet receiver to transmit the digital information addressed to the particular user to the user's personal computer.

Upstream requests are made by the user using a modem connection over a public switched telephone network with a terminating modem contained in the split channel bridging unit. Secured low-speed control information is supported bidirectionally using a modem connection over the public switched telephone network. However, multipoint-to-multipoint hierarchical redistribution of multimedia content is not disclosed in U.S. Pat. No. 5,534,913.

The assignee of the present invention also designs multimedia content distribution systems. However, the assignee of the present invention has not heretofore designed a multimedia content distribution system that provide for multipoint-to-multipoint hierarchical redistribution of multimedia content. Furthermore, it is not believed that are there currently available systems that provide multipoint-to-multipoint hierarchical redistribution of multimedia content.

Accordingly, it would be desirable to have improved methods and apparatus that provide multipoint-to-multipoint hierarchical redistribution of multimedia content. It would also be desirable to have methods and apparatus that effectively provides a standard internet point-to-point connection overlay to an existing cable TV system

### SUMMARY OF THE INVENTION

The present invention comprises systems and methods that provide multipoint-to-multipoint hierarchical redistribution of multimedia content. The present systems and methods may be used to receive direct video broadcast (DVB) multimedia content from multiple sources for reprocessing and redistribution.

More particularly, the present invention provides multipoint-to-multipoint hierarchical redistribution of multimedia content derived from one or more network operations centers that distributes multimedia content by way of a satellite. The present invention comprises one or more network operations bridges (NOBs) that communicate with and receive the multimedia content generated at the network operations center by way of the satellite. Each of the network operations bridges selectively communicate with one or more multimedia content delivery systems or user terminals that are relatively local to the respective network operations bridges.

The multimedia content is transmitted to one or more hierarchical destination network operations bridges (NOBs). Interfaces for sources of and destinations for the multimedia content may include a combination of one or more of the following: Ku-, C- or Ka-band satellites, VSAT, hybrid-fiber-coax CATV, an asymmetric digital subscriber line (ADSL), digital service (DS1-DS3), a fiber network, Local Multipoint Distribution Systems (LMDS), gigabit Ethernet, High Altitude Long Operation (HALO) aircraft based network, or other emerging broadband network.

Data delivered to a network operations bridge is processed to discard data that is not required or appropriate for a local market or network that is serviced by the network operations bridge. Inappropriate data, such as local programming from another locale or localized proprietary data, for example, is removed from the program stream and the table of contents associated with the revised data stream is modified to remove the listing of the discarded programming. Also, new programming may be added to the program stream and listings for the new programming are added to the table of contents in locations of discarded programming.

The modularized design of the network operations bridge makes it cost-efficient and technically advantageous to provide high quality information services over a widespread communication network around the globe. The hierarchical distributed architecture removes the “process and maintenance” burden from individual network operations centers.

The network operations bridge provides the ability to integrate existing satellite technologies (such as C-, Ku- or Ka-band; broadcast, VSAT, multibeam, and the like), terrestrial network technologies (such as cable TV, fiber, gigabit Ethernet, ISDN, PSTN, ADSL, and digital services, for example), and wireless technologies (such as LMDS and point-to-point microwave, for example). This integration of services and technologies has not previously been done.

### BRIEF DESCRIPTION OF THE DRAWINGS

The various features and advantages of the present invention may be more readily understood with reference to the following detailed description taken in conjunction with the accompanying drawings, wherein like reference numerals represent like structural elements, and in which

FIG. 1 illustrates a conceptual view of a network architecture employing a network operations bridge in accordance with the principles of the present invention;

FIG. 2 shows an elaborate conceptual configuration of the network operations bridge; and

FIG. 3 is a flow diagram that illustrates an exemplary method in accordance with the principles of the present invention.

### DETAILED DESCRIPTION

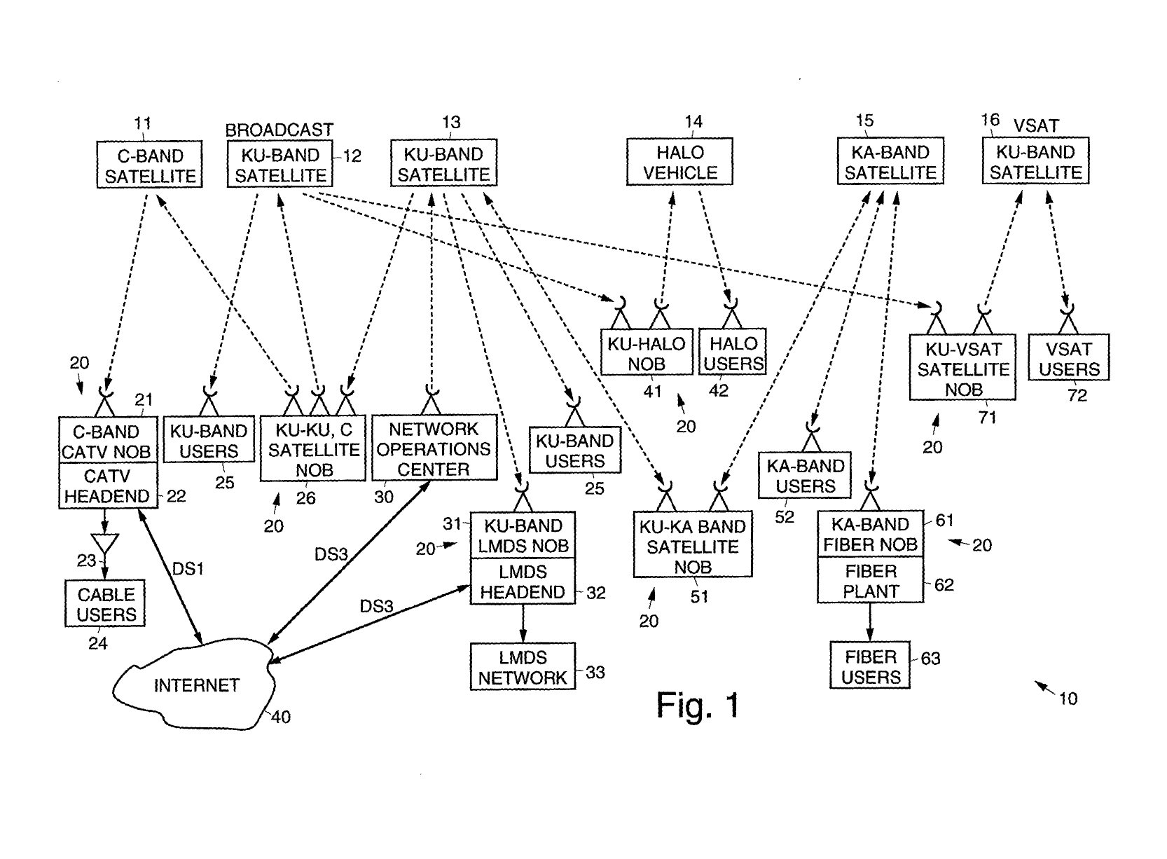

Referring to the drawing figures, FIG. 1 illustrates an exemplary embodiment of a network architecture 10 or system 10 employing a plurality of network operations bridges 20 in accordance with the principles of the present invention. Multimedia content available for distribution generally originates at one or more conventional network operations centers (NOCs) 30 (or content sources 30) located around the world. The multimedia content derived from the network operations centers 30 (or content sources 30) is typically delivered to a user community that is relatively local to the originating network operations center 30. However, such multimedia content may also be redistributed to other subscriber network operations centers 30 around the world using one or more network operations bridges 20 in accordance with the principles of the present invention. Alternatively, distribution of the multimedia content may be terminated at a particular network operations bridge 20 without further redistribution, and disseminated to a user community local to the terminating network operations bridge 20.

The exemplary network architecture 10 or system 10 may comprise one or more satellites, including a C-band satellite 11, a Ku-band broadcast satellite 12, a Ku-band satellite 13, a Ka-band satellite 15, and a Ku-band VSAT satellite 16. A High Altitude Long Operation (HALO) vehicle 14 may also be included in the network architecture 10 or system.

In the exemplary network architecture 10, the network operations center 30 distributes multimedia content which is uplinked to the Ku-band satellite 13 and downlinked from the Ku-band satellite 13 to a Ku-, Ku-, C-band satellite network operations bridge 26, to a Ku-band Local Multipoint Distribution System (LMDS) network operations bridge 31, and to a Ku-, Ka-band satellite network operations bridge 51 for redistribution. The uplinked multimedia content is also downlinked from the Ku-band satellite 13 to Ku-band terminals 25 used by Ku-band users.

The Local Multipoint Distribution System (LMDS) operates in the 25.25 to 27.5 GHz band. LMDS is a terrestrial, cellular, wireless communication service primarily intended to provide television distribution from hub stations located within relatively small cells to fixed subscriber receivers. LMDS is designed to provide a cost-effective alternative to cable television systems, especially in urban areas.

The LMDS network operations bridge 31 is coupled to an LMDS headend 32 that redistributes the multimedia content over an LMDS network 33 to its subscribers. The Ku-, Ka-band satellite network operations bridge 51 uplinks the multimedia content to the Ka-band satellite 15 which downlinks the multimedia content to Ka-band terminals 52. The Ka-band satellite 15 also downlinks the multimedia content to a Ka-band fiber network operations bridge 61. The Ka-band fiber network operations bridge 61 is coupled to a fiber plant 62 (or fiber optic network 62) that redistributes the multimedia content to user terminals 63 coupled to the fiber optic network 62.

The Ku-, Ku-, C-band satellite network operations bridge 26 uplinks the multimedia content to the Ku-band broadcast satellite 12 and to the C-band satellite 11 for redistribution. The Ku-band broadcast satellite 12 retransmits the uplinked multimedia content to Ku-band terminals 25. The Ku-band broadcast satellite 12 also retransmits the uplinked multimedia content to a Ku-band High Altitude Long Operation (HALO) network operations bridge 41. The Ku-band HALO network operations bridge 41 uplinks the multimedia content to the HALO vehicle 14 for redistribution to HALO terminals 42. The Ku-band broadcast satellite 12 also retransmits the uplinked multimedia content to a Ku-VSAT (very small aperture terminal) satellite network operations bridge 71. The Ku-VSAT satellite network operations bridge 71 uplinks the multimedia content to the Ku-band VSAT satellite 16 which downlinks the multimedia content to VSAT terminals 72.

The C-band satellite 11 retransmits the uplinked multimedia content to a C-band cable television (CATV) network operations bridge 21. The CATV network operations bridge 21 is coupled to a CATV headend 22 which redistributes the multimedia content to cable users 24 by way of a cable 23. Also the CATV headend 22 may redistribute the multimedia content by way of the Internet 40 using a digital service (DS1) link, for example. The network operations center 30 is also coupled to the Internet 40 using a digital service (DS3) link, for example. Similarly, the LMDS headend 32 is coupled to the Internet 40 using a digital service (DS3) link, for example.

As may be seen from FIG. 1, the network operations bridge 20 may be used to replace of a network operations center 30 in remote regions covering a small network of users. FIG. 1 illustrates the use of seven such network operations bridges 20 that are used to interface with the CATV headend 22, the C-band satellite 11, the Ku-band broadcast satellite 12, the Ku-band satellite 13, the LMDS headend 32, the HALO vehicle 14, the Ka-band satellite 15, and the VSAT Ku-band satellite 16.

The various network operations bridges 20 may be configured for manned or unmanned operation. Incoming multimedia content streams received at each network operations bridge 20 may contain services and programs not suitable (in whole or in part) for the local region serviced by the network operations bridge 20. The inappropriate services may be selectively removed, replaced, or modified by the network operations bridge 20.

The network operations bridge 20 may be used to inject or insert additional services and programs such as Internet content and/or additional multimedia content that are applicable and marketable to a local region. The multimedia content may be injected at the network operations bridge 20, either in whole or in part. Whole multimedia content is generally in a form ready to be offered for sale, such as a complete movie, for example. Partial multimedia content is generally content that enhances, modifies, adds value to, and/or complements the source content, such as an advertisement inserted into a movie, for example.

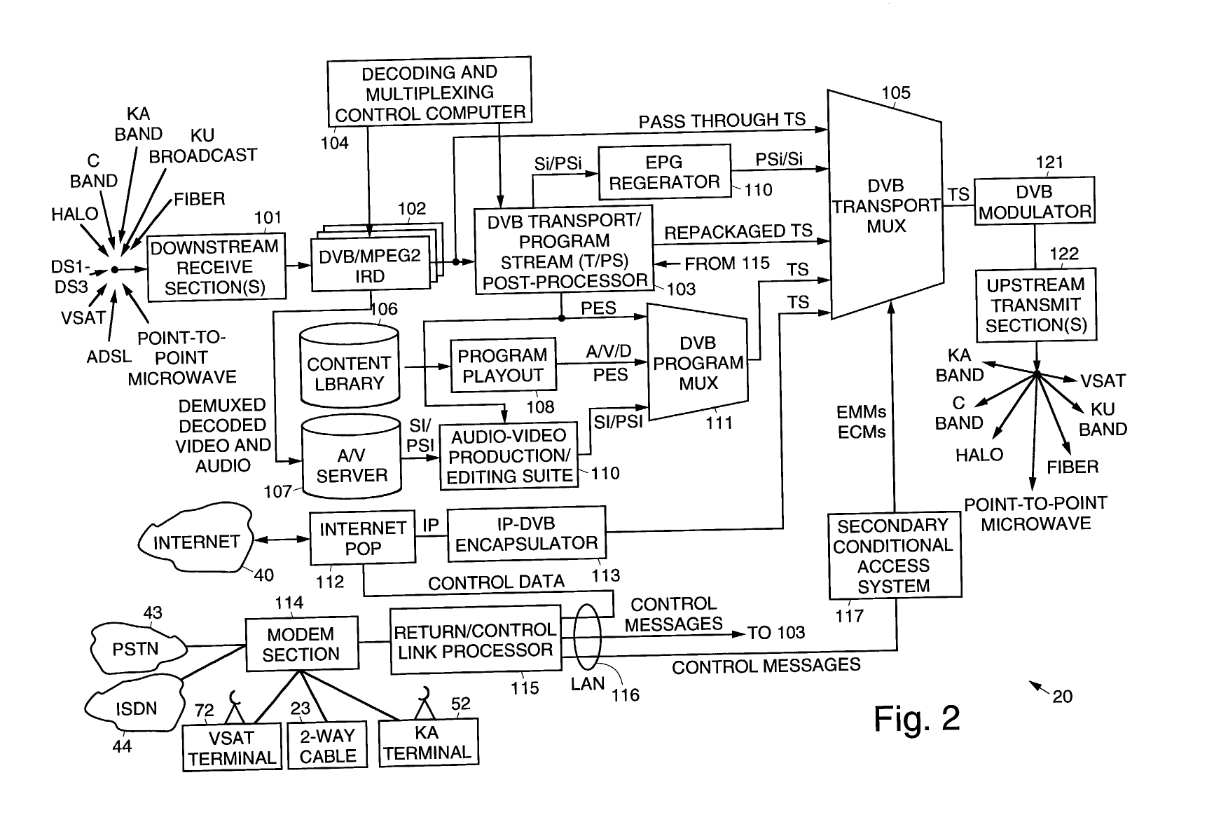

Insertion of the additional services and programs using the network operations bridge 20 is implemented as follows. If the network operations bridge 20 is manned, then the operators will have the ability to modify the services and programs using the various computers and processors identified in FIG. 2. If the network operations bridge 20 in unmanned, and hence either static or remotely controlled by the network operations center 30, a link is required from the network operations center 30 to the network operations bridge 26 for sending control messages to the return/control link processor 115 via PSTN 43 or ISDN 44, through the modem 114 (in FIG. 2). The operators of the network operations center 30 will send the necessary configuration tables to the network operations bridge processor 115, such that it can configure or reconfigure.

The network operations bridge 20 processes multimedia content data (content) and control data. The communication link that carries the multimedia content data is not always necessarily the same link that carries control data. The network operations bridge 20 may be configured and tailored to each local region's needs for multimedia content as well as its communication requirements. A better understanding of the design and operation of the network operations bridge 20 is provided with reference to FIG. 2.

FIG. 2 shows a block diagram of a fully configured network operations bridge 20. A simplified network operations bridge 20 may be constructed using a Media Node 240 available from Divicon Incorporated, for example. The Media Node 240 was used to produce a prototype of the network operations bridge 20. The Media Node 240 may be used to remove programs from and add programs to a program stream processed thereby. The Media Node 240 was modified to permit unmanned operation and processing of table of contents listings. Unmanned operation is achieved by sending SNMP control messages via PSTN 43 or ISDN 44, through the modem 114 to the return/control link processor which in this case is functionally contained in the Media Node 240.

Many of the components used in the network operations bridge 20 are optional and are configurable. The network operations bridge 20 may be configured as simply or as complex as is required for a particular application. A simply configured network operations bridge 20 is one that operates as a pass-through repeater. As the network operations bridge 20 becomes more complicated, more closely resembles a network operations center 30, but without any business support systems, such as finance systems or subscriber management systems.

As is shown in FIG. 2, the fully configured network operations bridge 20 comprises one or more downstream receiving sections 101 that are used to receive multimedia content derived from a fiber 62, Ku-band broadcast satellite 12, Ka-band satellite 15, C-band satellite 11, HALO vehicle 14, digital signals (DS1-DS3), the VSAT Ku-band satellite 16, asymmetric digital subscriber line (ADSL) and point-to-point (Ku-band LMDS) microwave link. The downstream receiving sections 101 output the received multimedia content to one or more digital video broadcast (DVB) MPEG-2 integrated receiver decoders (IRD) 102.

The DVB MPEG-2 integrated receiver decoders 102 output a passthrough transport stream (TS) to a DVB transport multiplexer (MUX) 105. The DVB MPEG-2 integrated receiver decoders 102 also output the multimedia content to a DVB transport/program stream (T/PS) post-processor 103 that produces a repackaged transport stream that is sent to the DVB transport multiplexer 105. The post-processor 103 repackages the transport stream in order to provide a single combined modified transport stream for combination with pass through multimedia data from 102 and the locally inserted program from 111. A decoding and multiplexing control computer 104 is used to control the DVB MPEG-2 integrated receiver decoders 102 and the postprocessor 103. Control of the integrated receiver decoders 102 and the post-processor 103 is performed in a routine manner.

The post-processor 103 outputs a program specific information and service information (PSI/Si) data stream to an electronic program guide (EPG) regenerator 110. The EPG regenerator 110 generates a program specific information and service information (PSI/Si) data stream that is sent to the DVB transport multiplexer 105. The post-processor 103 also outputs a PES data stream to a DVB program multiplexer 111 and to an audio-video production editing suite 110. The PES data stream is a packetized elementary stream of video and audio data packets and ancillary data of undefined length.

The DVB MPEG-2 integrated receiver decoders 102 outputs a demultiplexed and decoded video and audio stream to an audio-video server 107. The audio-video production editing suite 110 processes data derived from the audio-video server 107 and outputs an audio-video PES data stream that is input to the DVB program multiplexer 111. A content library 106 is coupled to program playout circuitry 108 which outputs an audio, video and data PES data stream that is input to the DVB program multiplexer 111. The DVB program multiplexer 111 outputs multiplexed data comprising the transport stream (TS) that is input the DVB transport multiplexer 105.

An Internet point of presence (POP) server 112 interfaces to the Internet 40 and route Internet protocol (IP) data by way of an Internet protocol-digital video broadcast (IP/DVB) encapsulator that outputs a transport stream (TS) that is input the DVB transport multiplexer 105. A Public Service Telephone Network (PSTN) 43, an Integrated Services Digital Network (ISDN) 44, a VSAT terminal 72, a cable 23, and a Ka-band terminal 52 are coupled to a modem section 114 containing one or more appropriate modems. The modems of the modem section 114 interface to a return/control link processor 115 that interfaces to a local area network (LAN) 116 which is used to route control messages to the post-processor 103 and a secondary conditional access system 117, and control data to the Internet POP server 112. The secondary conditional access system 117 is coupled to the DVB transport multiplexer 105 and routes control messages thereto.

The output of the DVB transport multiplexer 105 is coupled to a digital video broadcast (DVB) modulator 121 which modulates the transport streams. The modulated transport streams are routed to one or more upstream transmit sections 122 which transmit the transport streams over the respective links to the fiber, the Ku-band broadcast satellite 12, the Ka-band satellite 15, the C-band satellite 11, the HALO vehicle 14, the VSAT Ku-band satellite 16, and the point-to-point (Ku-band LMDS) microwave link.

The secondary conditional access system 117 may be a system different from that used by the network operations center 30. The network operations bridge 20 may also provide multicasting service where content received from the network operations center 30 is further redistributed to more than one additional network operations bridge 20 and/or network operations center 30 either as-is or in a repackaged state.

The DVB transport/program stream (T/PS) post-processor 103 accesses only that part of the transport stream to which it is authorized using a conditional access system of the receiving integrated receiver decoder 102. Control messages are transmitted along with the data to configure the conditional access privileges of the postprocessor 103. The chassis of the receiving integrated receiver decoder 102 may be configured to house multiple IRDs, each of which can simultaneously handle a significant (5-10 times) larger number of program identifiers (PIDs) than those available for public consumption.

The downstream sections 101 accept multiple transport streams originated from multiple sources such as satellite or terrestrial networks, or transponders, and the like. The network operations bridge 20 is SNMP-based and contains a Management Information Base (MIB) so that it may be operated in an unmanned state at all times and may be remotely controlled by a controlling network operations center 30.

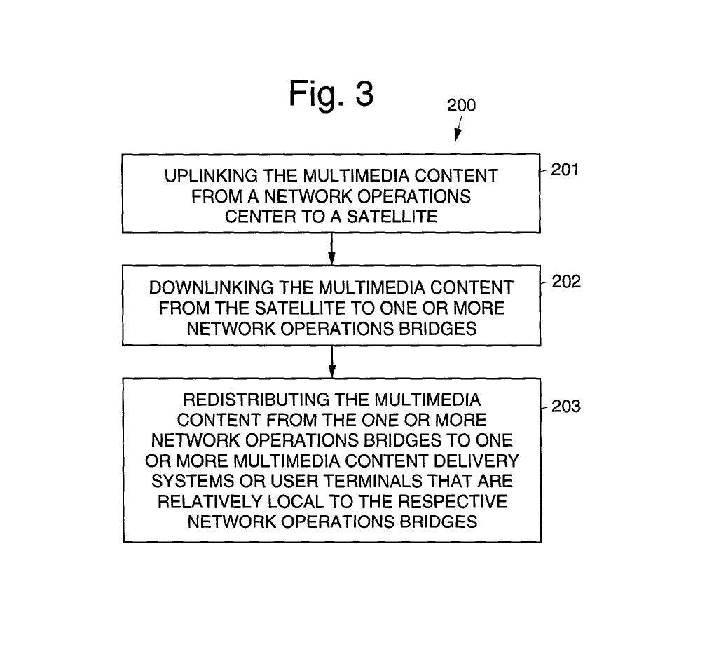

Referring now to FIG. 3, it is a flow diagram that illustrates an exemplary method 200 in accordance with the principles of the present invention. The exemplary method 200 provides multipoint-to-multipoint hierarchical redistribution of multimedia content derived from one or more network operations centers 30 that distributes multimedia content by way of a satellite. The exemplary method 200 comprises the following steps.

The multimedia content is uplinked 201 from a network operations center 30 to the satellite 13. The multimedia content is downlinked 202 from the satellite 13 to one or more network operations bridges 20. The multimedia content is redistributed 203 from the one or more network operations bridges to one or more multimedia content delivery systems 22, 32, 14, 16, 62 or user terminals 25, 52, 72 that are relatively local to the respective network operations bridges.

Uplinking 201 the multimedia content to the satellite 13 may comprise selectively uplinking 201 the multimedia content to a satellite 13 selected from the group consisting of a C-band satellite 11, a Ku-band broadcast satellite 12, a Ku-band satellite 13, a Ka-band satellite 15, and a Ku-band VSAT satellite 16. Downlinking 202 the multimedia content may comprise selectively downlinking 202 the multimedia content to a Ku-, Ku-, C-band satellite network operations bridge 26, a Ku-band Local Multipoint Distribution System (LMDS) network operations bridge 31, and a Ku-, Ka-band satellite network operations bridge 51.

Downlinking 202 the multimedia content may comprise downlinking 202 the multimedia content to a High Altitude Long Operation network operations bridge 41 that communicates with users 42 by way of a High Altitude Long Operation vehicle 14. Downlinking 202 the multimedia content may also comprise redistributing the multimedia content by way of the Ku-, Ku-, C-band satellite network operations bridge 26 and the Ku-band satellite 13 to Ku-band terminals 25. Downlinking 202 the multimedia content may comprise redistributing the multimedia content by way of the LMDS network operations bridge 31, an LMDS headend 32 and an LMDS network 33 to subscribers.

Redistributing 203 the multimedia content from the one or more network operations bridges to one or more multimedia content delivery systems 22, 32, 14, 16, 62 may further comprise redistributing 203 the multimedia content by way of a Ku-, Ka-band satellite network operations bridge 51 and a Ka-band satellite 15 to Ka-band terminals 52. Redistributing 203 the multimedia content may further comprise redistributing the multimedia content by way of the Ku-, Ka-band satellite network operations bridge 51 and Ka-band satellite 15 to a Ka-band fiber network operations bridge 61. Redistributing 203 the multimedia content may also comprise redistributing 203 the multimedia content by way of a Ku-VSAT satellite network operations bridge 71 and the Ku-band broadcast satellite 12 to VSAT terminals 72. The method 200 may also comprise the step of redistributing the multimedia content from the Ka-band fiber network operations bridge 61 and a fiber plant 62 coupled to user terminals 63.

Thus, improved methods and apparatus that provide multipoint-to-multipoint hierarchical redistribution of multimedia content have been disclosed. It is to be understood that the described embodiments are merely illustrative of some of the many specific embodiments which represent applications of the principles of the present invention. Clearly, numerous and other arrangements can be readily devised by those skilled in the art without departing from the scope of the invention.

What is claimed is:

1. Apparatus that provides multipoint-to-multipoint hierarchical redistribution of multimedia content derived from one or more network operations centers that distributes multimedia content by way of a satellite, comprising:
one or more network operations bridges that communicate with and receive the multimedia content generated at the network operations center by way of the satellite 13, each of the network operations bridges selectively communicating with one or more multimedia content delivery systems or user terminals that are relatively local to the respective network operations bridges.

2. The apparatus recited in claim 1 wherein the network operations bridges communicate with the one or more multimedia content delivery systems by way of one or more satellites, selected from the group consisting of a C-band satellite, a Ku-band broadcast satellite, a Ku-band satellite, a Ka-band satellite, and a Ku-band VSAT satellite.

3. The apparatus recited in claim 2 wherein the network operations bridges include a Ku-, Ku-, C-band satellite network operations bridge, a Ku-band Local Multipoint Distribution System (LMDS) network operations bridge, and a Ku-, Ka-band satellite network operations bridge.

4. The apparatus recited in claim 1 wherein the network operations bridges comprise a High Altitude Long Operation network operations bridge that communicates with users by way of a High Altitude Long Operation vehicle.

5. The apparatus recited in claim 3 wherein the Ku-, Ku-, C-band satellite network operations bridge redistributes the multimedia content by way of the Ku-band satellite to Ku-band terminals.

6. The apparatus recited in claim 2 wherein the LMDS network operations bridge is coupled to an LMDS headend that redistributes the multimedia content over an LMDS network 33 to its subscribers.

7. The apparatus recited in claim 1 further comprising a Ku-, Ka-band satellite network operations bridge that redistributes the multimedia content by way of a Ka-band satellite to Ka-band terminals.

8. The apparatus recited in claim 7 wherein the Ku-, Ka-band satellite network operations bridge and Ka-band satellite also redistributes the multimedia content to a Ka-band fiber network operations bridge.

9. The apparatus recited in claim 8 wherein the Ka-band fiber network operations bridge redistributes the multimedia content by way of a fiber plant coupled to user terminals.

10. The apparatus recited in claim 2 further comprising a Ku-VSAT satellite network operations bridge that redistributes the multimedia content derived from the Ku-band broadcast satellite to VSAT terminals.

11. A method for providing multipoint-to-multipoint hierarchical redistribution of multimedia content derived from one or more network operations centers that distributes multimedia content by way of a satellite, comprising the steps of:
uplinking the multimedia content from a network operations center to the satellite;
downlinking the multimedia content from the satellite to one or more network operations bridges;
redistributing the multimedia content from the one or more network operations bridges to one or more multimedia content delivery systems or user terminals that are relatively local to the respective network operations bridges.

12. The method recited in claim 11 wherein the step of uplinking the multimedia content to the satellite comprises the step of selectively uplinking the multimedia content to a satellite selected from the group consisting of a C-band satellite, a Ku-band broadcast satellite, a Ku-band satellite, a Ka-band satellite, and a Ku-band VSAT satellite.

13. The method recited in claim 11 wherein the step of downlinking the multimedia content to one or more network operations bridges comprises the step of selectively downlinking the multimedia content to a Ku-, Ku-, C-band satellite network operations bridge, a Ku-band Local Multipoint Distribution System (LMDS) network operations bridge, and a Ku-, Ka-band satellite network operations bridge.

14. The method recited in claim 11 wherein the step of downlinking the multimedia content to one or more network operations bridges comprises the step of downlinking the multimedia content to a High Altitude Long Operation network operations bridge that communicates with users by way of a High Altitude Long Operation vehicle.

15. The method recited in claim 13 wherein the step of downlinking the multimedia content to one or more network operations bridges comprises the step of redistributing the multimedia content by way of the Ku-, Ku-, C-band satellite network operations bridge and the Ku-band satellite to Ku-band terminals.

16. The method recited in claim 13 wherein the step of downlinking the multimedia content to one or more network operations bridges comprises the step of redistributing the multimedia content by way of the LMDS network operations bridge, an LMDS headend and an LMDS network to subscribers.

17. The method recited in claim 11 wherein the step of redistributing the multimedia content from the one or more network operations bridges to one or more multimedia content delivery systems further comprises the step of redistributing the multimedia content by way of a Ku-, Ka-band satellite network operations bridge and a Ka-band satellite to Ka-band terminals.

18. The method recited in claim 11 wherein the step of redistributing the multimedia content from the one or more network operations bridges further comprises the step of redistributing the multimedia content by way of the Ku-, Ka-band satellite network operations bridge and Ka-band satellite to a Ka-band fiber network operations bridge 1.

19. The method recited in claim 18 further comprising the step of redistributing the multimedia content from the Ka-band fiber network operations bridge and a fiber plant coupled to user terminals.

20. The method recited in claim 12 wherein the step of redistributing the multimedia content from the one or more network operations bridges to one or more multimedia content delivery systems further comprises the step of redistributing the multimedia content by way of a Ku-VSAT satellite network operations bridge and the Ku-band broadcast satellite to VSAT terminals.
